(19) United States
(12) Patent Application Publication
(10) Pub. No.: US 2012/0216369 A1
(43) Pub. Date: Aug. 30, 2012

(54) Assembly for Cleaning with Focused High Pressure Air

(76) Inventor: Peter Vinci, Shandaken, NY (US)

(21) Appl. No.: 13/108,084

(22) Filed: May 16, 2011

Related U.S. Application Data
(60) Provisional application No. 61/447,348, filed on Feb. 28, 2011.

(51) Int. Cl. B08B 5/02

(52) U.S. Cl. 15/405

(57) ABSTRACT

An assembly comprises an air blow gun and an extension tube. The extension tube is in fluid communication with an output of the air blow gun. Moreover, the extension tube has a closed distal end and comprises a tubular sidewall. The tubular sidewall defines a plurality of apertures therein. The air blow gun is operative to regulate the flow of a gas through the plurality of apertures.

### BACKGROUND OF THE INVENTION

Large motorized machines such as semi-trailer trucks, ships, farm tractors, and military tanks commonly utilize cylinder- or tube-style air filters to remove contaminants from engine intake air. When used on a semi-trailer truck, for example, a hollow cylindrical air filter is usually housed next to the truck's engine compartment in an external cylindrical housing. This housing is designed to route engine intake air through the sidewall of the hollow cylindrical air filter before it enters the vehicle's intake system. Webs of fiber forming the sidewall of the filter trap and remove any contaminants from the air before these contaminants can enter the motor and cause engine wear and damage.

For an engine to achieve maximum fuel efficiency, its air intake system must be able to accept air in high volumes with minimum resistance. Nevertheless, as a hollow cylindrical air filter traps contaminants, its ability to pass air without undue restriction diminishes. Accordingly, such an air filter must be periodically cleaned or replaced as part of routine maintenance in order to avoid a reduction in engine efficiency. One manner of cleaning a hollow cylindrical air filter involves blowing high pressure air from the inside of the air filter through its fiber sidewall towards the outside of the filter. The high pressure air dislodges trapped contaminants and at least partially restores the filter's capacity to trap contaminants and pass air without undue restriction. Of course, similar methods may also be used to clean oval air filters, condensers, radiators, and the like.

A source of compressed air is commonly found in engine maintenance shops. Despite this, however, the inventors are aware of no existing assemblies that allow focused high pressure air to be directed at the hard-to-reach areas of cylinder- and tube-style air filters, oval air filters, condensers, and radiators in an easy and efficient manner. For this reason, such assemblies are highly desirable.

### SUMMARY OF THE INVENTION

Embodiments of the present invention address the above-identified need by providing assemblies allowing a focused stream of high pressure air to be directed at the hard-to-reach areas of cylinder- and tube-style air filters, oval air filters, condensers, radiators, and the like in an easy and efficient manner.

In accordance with an aspect of the invention, an assembly comprises an air blow gun and an extension tube. The extension tube is in fluid communication with an output of the air blow gun. Moreover, the extension tube has a closed distal end and comprises a tubular sidewall. The tubular sidewall defines a plurality of apertures therein. The air blow gun is operative to regulate the flow of a gas through the plurality of apertures.

An embodiment of the invention includes an extension tube that is threaded onto the output of an air blow gun. The extension tube comprises a tubular sidewall and is closed at its distal end. A series of round apertures in the sidewall are arranged in a line proximate to the closed end of the extension tube. Actuating the air blow gun causes compressed air to enter the extension tube and to be forced through the series of apertures as a focused stream of high pressure air that is directed substantially normal to the longitudinal axis of the extension tube.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of an assembly in accordance with a first illustrative embodiment of the invention while in use;

FIG. 2 shows another perspective view of the FIG. 1 assembly;

FIG. 3 shows a perspective view of the distal end of the FIG. 1 assembly;

FIGS. 4a and 4b show a perspective view and a side elevational view, respectively, of a first alternative extension tube for use with the FIG. 1 assembly;

FIGS. 5a and 5b show a perspective view and a side elevational view, respectively, of a second alternative extension tube for use with the FIG. 1 assembly;

FIGS. 6a, 6b, and 6c show a perspective view, a sectional view, and another perspective view, respectively, of a third alternative extension tube for use with the FIG. 1 assembly with the addition of a rotating sleeve; and

FIG. 7 shows a perspective view of an assembly in accordance with a second illustrative embodiment of the invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

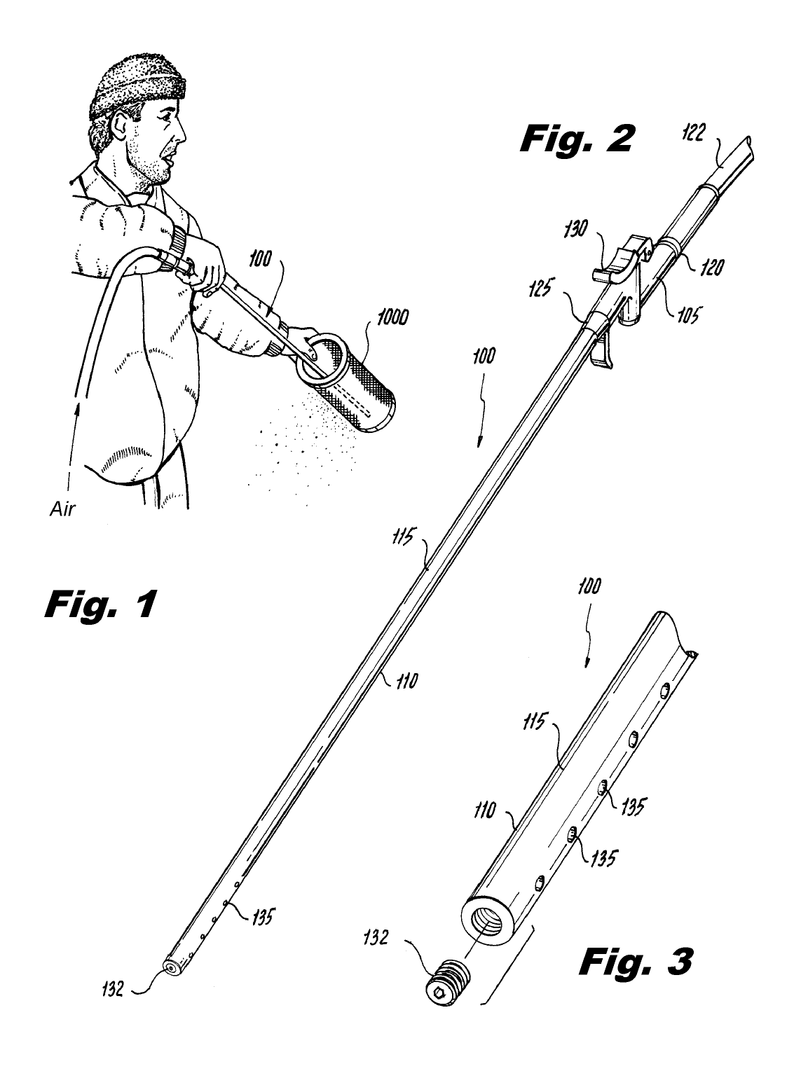

FIGS. 1-3 show various views of an assembly 100 in accordance with a first illustrative embodiment of the invention. More particularly, FIG. 1 shows a perspective view of the assembly 100 while in use to clean a cylinder-style air filter 1000, FIG. 2 shows another perspective view of the assembly 100 with additional details visible, and, finally, FIG. 3 shows a perspective view of the distal end of the assembly 100. At its most basic level, the assembly 100 can be separated into an air blow gun 105 and an extension tube 110 with a tubular sidewall 115.

The air blow gun 105 itself comprises an inlet port 120, an outlet port 125, and an internal valve (not explicitly shown). When in use, pressurized air (or any other chosen gas) is fed to the inlet port 120 via a conventional high pressure hose 122. The pressurized air may originate at, for example, a conventional air compressor. The internal valve in the air blow gun 105 is actuated by a handle 130. When the handle 130 is depressed, the internal valve opens and causes pressurized air to be transported through the air blow gun 105 from the inlet port 120 to the outlet port 125. When released, the internal valve is closed and no pressurized air is passed through the air blow gun 105.

In this way, the air blow gun 105 is largely conventional and may be obtained from a number of commercial sources. Air blow guns compatible with aspects of this invention are available from, as just two examples, Sears Holdings Corporation (Hoffman Estates, Ill., USA) and Northern Tool+Equipment (Burnsville, Minn., USA). As is conventional, the inlet port 120 and the outlet port 125 of the air blow gun 105 may be configured with National Pipe Thread Tapered Thread (NPT).

The extension tube 110 comprises a cylindrical hollow tube threaded at its proximal end (i.e., the end which attaches to the air blow gun 105) with threading complementary to the threading at the outlet port 125 of the air blow gun 105. This allows the extension tube 110 to be connected to the outlet port 125 by simply screwing the extension tube 110 into the outlet port 125, thereby putting the extension tube 110 in fluid communication with an output of the air blow gun 105. The distal end of the extension tube 110 (i.e., the end opposite the air blow gun 105), in contrast, is closed off. Closure of the distal end of the extension tube 110 in the present embodiment is accomplished by simply threading a set screw 132 into the extension tube 110, although other means of closure, such as, but not limited to, a welded or crimped end may also be utilized. The total length of the extension tube 110 may be, for example, between 12 and 36 inches, depending on the application, and the extension tube 110 may be formed of a metal (e.g., steel, copper, or aluminum) or a plastic. It may have a tube sidewall thickness of, for instance, 0.064 inches.

In accordance with aspects of the invention, the tubular sidewall 115 of the extension tube 110 defines a plurality of apertures 135 (i.e., holes). These apertures 135 are located proximate to the distal end of the extension tube 110 and are arranged in a line running parallel to a longitudinal axis of the extension tube 110. As shown in FIG. 3, the apertures 135 in the particular embodiment shown therein are circular and evenly spaced. The apertures 135, may, for example, have a diameter of 0.05 inches and a hole-center-to-hole-center spacing (hereinafter “aperture pitch”) of 0.5 inches. Nevertheless, these particular dimensions are merely illustrative and other suitable dimensions may also be utilized.

Once the extension tube 110 is connected to the air blow gun 105, operation of the handle 130 causes pressurized air to enter the extension tube 110 and rapidly travel towards the extension tube's distal end. Air pressure is thereby built up in the extension tube 110 and vented through the apertures 135 to create a focused high pressure output stream that is directed substantially normal to the longitudinal axis of the extension tube 110. This focused high pressure output stream is ideal for cleaning cylinder- and tube-style air filters, as well as for cleaning oval air filters. As shown in FIG. 1, for a cylinder- or tube-style air filter, for example, the operator can simply insert the extension tube 110 into the hollow center of the filter and blow high pressure air from the inside of the air filter through the filter's fiber sidewall towards the outside of the filter. The high pressure air dislodges trapped contaminants and at least partially restores the filter's capacity to trap contaminants and pass air without undue restriction. The assembly 100 can also be utilized to clean hard-to-reach portions of radiators, condensers, and the like.

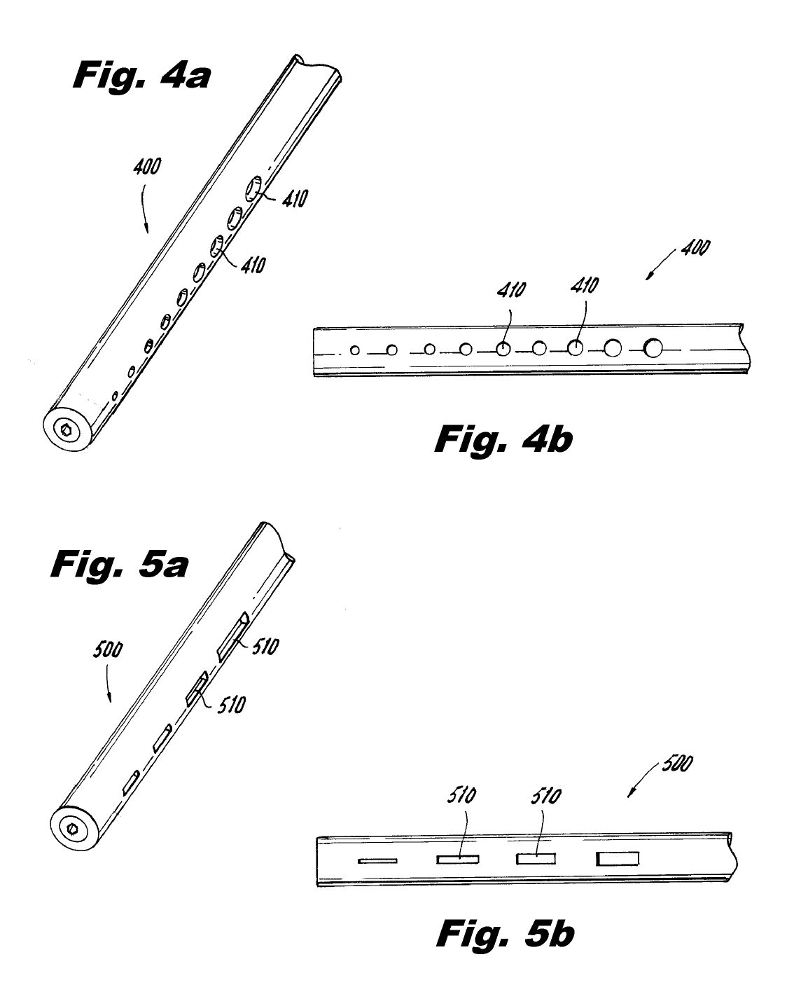

While the apertures 135 in the assembly 100 shown in FIGS. 1-3 are circular, are of equal size, and have a constant aperture pitch, many other aperture designs and arrangements may be utilized and the results would still come within the scope of the invention. FIGS. 4a and 4b, for example, shows a first alternative extension tube 400. More particularly, FIG. 4a shows a perspective view of the distal end of the extension tube 400 with apertures 410, while FIG. 4b shows a side elevational view of the same extension tube 400. Here, the apertures 410 are substantially circular and are again arranged in a line running parallel to the longitudinal axis of the extension tube 400, but vary progressively in diameter and aperture pitch. In one exemplary configuration, there are nine apertures 410, and the apertures 410 progressively decrease from a diameter of 0.100 inches to a diameter of 0.060 inches as one moves closer to the distal end of the extension tube 410. In contrast, the aperture pitch progressively increases from 0.1825 inches to 0.200 inches when moving in the same direction. The apertures 410 therefore get smaller and farther apart as one moves away from the air blow gun 105.

Notably, the progressive change in both aperture diameter and aperture pitch has been empirically observed to make the focused high pressure output of the apertures 135 more uniform. Without such an arrangement, pressure may be uneven, namely, higher closer to the distal end of the extension tube. The progressive change in aperture diameter and aperture pitch is therefore preferred, but, at the same time, certainly not necessary.

FIGS. 5a and 5b go onto show a second alternative extension tube 500. FIG. 5a shows a perspective view of the distal end of the extension tube 500 with apertures 510, while FIG. 5b shows a side elevational view of the same extension tube 500. In this case, the apertures 510 are rectangular and vary in size along a line running parallel to the longitudinal axis of the extension tube 500. Other aperture shapes (e.g., hexagonal, square, and oval) are also clearly available.

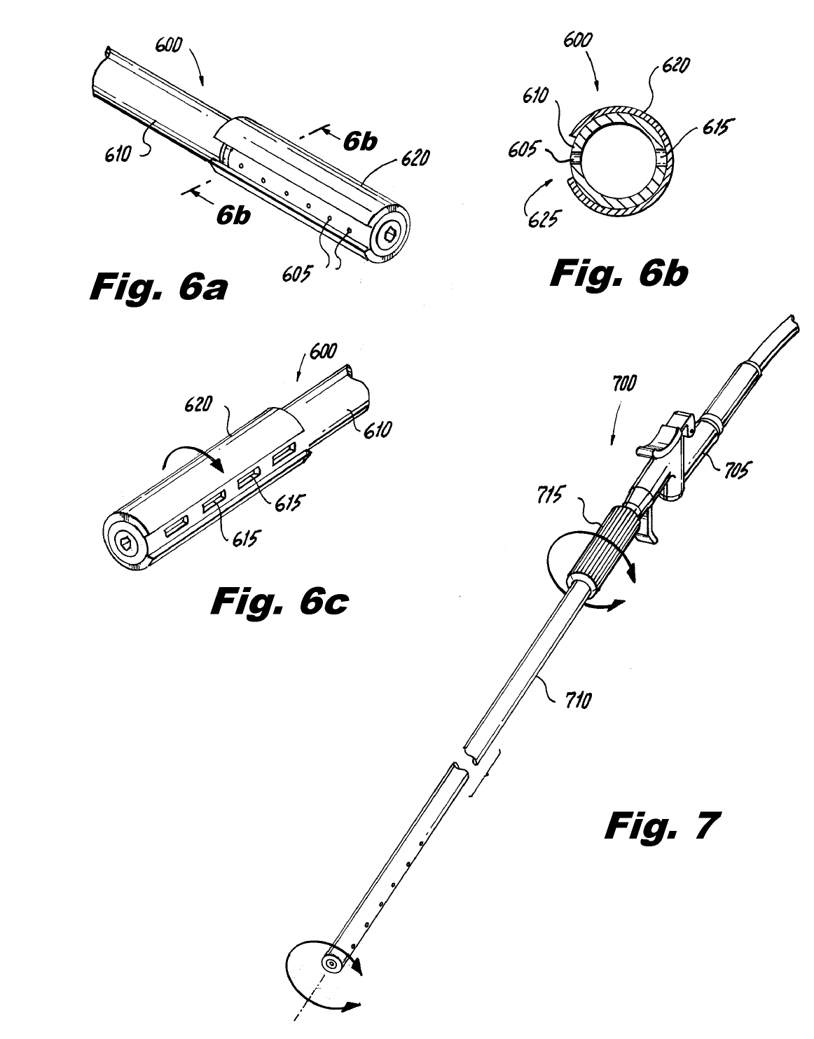

Moreover, an assembly in accordance with aspects of the invention may include a tubular sidewall that defines multiple sets of apertures so that the user may choose from different apertures for different applications. FIGS. 6a-6c show a third alternative extension tube 600, with FIGS. 6a and 6c showing perspective views of the distal end of the extension tube 600, and FIG. 6b showing a sectional view cut along the plane indicated in FIG. 6a. The extension tube 600 includes both a first set of substantially circular apertures 605 arranged in a first line on one side of its tubular sidewall 610 (visible in FIG. 6a), and a second separate set of substantially rectangular apertures 615 arranged in a second line on the opposite side of the tubular sidewall 610. A rotatable sleeve 620 is attached to the extension tube 600 and allows the user to select between first and second aperture sets 605, 615. In this embodiment, the rotatable sleeve 620 comprises a hollow partially cylindrical body that conforms to the outside of the tubular sidewall 610. A slot 625 in the rotatable sleeve 620 exposes one set of apertures while the remaining set of apertures remains covered.

With such a rotatable sleeve 620, choosing the set of apertures 605 or 615 for a particular application merely involves rotating the rotatable sleeve 620 so that the selected set of apertures is exposed by the slot 625. Of course, while the above-described extension tube 600 includes just two sets of apertures, a single extension tube might include many more sets (e.g., 5 different sets of apertures). An alternative embodiment may even have two substantially identical sets of apertures on opposed sides of the extension tube 600. This last arrangement has the advantage of allowing the user, again utilizing the rotatable sleeve 620, to choose in which of the two opposed directions the user wishes to direct the focused high pressure output stream without also requiring that the user select between sets of apertures with different flow characteristics.

Lastly, FIG. 7 shows an assembly 700 in accordance with a second illustrative embodiment of the invention. Like the assembly 100, the assembly 700 includes an air blow gun 705 and an extension tube 710. However, interposed between these elements is a rotary union 715 (i.e., rotating joint). The rotary union 715 allows the extension tube 710 to be rotated about its longitudinal axis without having to rotate the air blow gun 705 itself. The user is thereby able to easily redirect the focused high pressure output stream without having to twist his hand in an awkward manner. This makes many cleaning jobs substantially easier. Rotary unions of the type that may be used in the present application are commercially available from, for example, Deublin Company (Waukegan, Ill., USA).

It should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. An assembly comprising:
an air blow gun; and
an extension tube in fluid communication with an output of the air blow gun, the extension tube having a closed distal end and comprising a tubular sidewall defining a plurality of apertures therein;
wherein the air blow gun is operative to regulate the flow of a gas through the plurality of apertures.

2. The assembly of claim 1, wherein the plurality of apertures are disposed proximate to the closed distal end of the extension tube.

3. The assembly of claim 1, wherein the plurality of apertures are arranged along a line running parallel to a longitudinal axis of the extension tube.

4. The assembly of claim 1, wherein the extension tube is adapted to be threaded onto the air blow gun.

5. The assembly of claim 1, wherein the closed distal end of the extension tube is closed with an inserted set screw.

6. The assembly of claim 1, wherein the plurality of apertures comprises an aperture that is substantially round.

7. The assembly of claim 1, wherein the plurality of apertures comprises an aperture that is substantially rectangular.

8. The assembly of claim 1, wherein the plurality of apertures comprises at least one aperture that is substantially round and at least one aperture that is substantially rectangular.

9. The assembly of claim 1, wherein the plurality of apertures comprises two apertures with substantially different sizes.

10. The assembly of claim 1, wherein the plurality of apertures comprises four or more apertures arranged in a line running parallel to a longitudinal axis of the extension tube.

11. The assembly of claim 10, wherein the four or more apertures progressively decrease in size in the direction towards the closed distal end of the extension tube.

12. The assembly of claim 10, wherein the four or more apertures progressively increase in aperture pitch in the direction towards the closed distal end of the extension tube.

13. The assembly of claim 10, wherein the four or more apertures progressively decrease in size and progressively increase in aperture pitch in the direction towards the closed distal end of the extension tube.

14. The assembly of claim 1, wherein the plurality of apertures comprises two or more first apertures arranged in a first line running parallel to a longitudinal axis of the extension tube and two or more second apertures arranged in a second line running parallel to the longitudinal axis of the extension tube.

15. The assembly of claim 1, further comprising a sleeve, the sleeve comprising a hollow partially cylindrical body that partially encircles a portion of the extension tube.

16. The assembly of claim 15, wherein the sleeve is configured to be rotatable about a longitudinal axis of the extension tube.

17. The assembly of claim 1, further comprising a rotary union, the rotary union disposed between the extension tube and the air blow gun and allowing the extension tube to rotate in relation to the air blow gun.
